(19) United States
(12) Patent Application Publication
(10) Pub. No.: US 2013/0117160 A1
(43) Pub. Date: May 9, 2013

(54) SYSTEM AND METHOD FOR SELECTING CONTENT FOR PUBLICATION

(71) Applicants: Jesse Potash, Islip, NY (US); Hellen Barbara, Islip, NY (US)

(72) Inventors: Jesse Potash, Islip, NY (US); Hellen Barbara, Islip, NY (US)

(21) Appl. No.: 13/291,772

(22) Filed: Nov. 8, 2011

(51) Int. Cl. G06Q 30/06

(52) U.S. Cl. 705/27.1

(57) ABSTRACT

There is provided a system and method for selecting content for publication. The system and method includes modules for submitting content, discovering and funding content, selecting content and selling content. More particularly, content is selected based on the number of users of a community of users supporting the content.

### FIELD OF THE INVENTION

This invention relates generally to the field of selecting content for publication via a Web application. More specifically, this invention involves a system and method for obtaining content from users and selecting from the obtained content, content for publication.

### BACKGROUND OF THE INVENTION

Throughout the twentieth century and into the twenty-first century, the publishing industry existed with minimal significant change. The traditional publishing structure is based around large publishing companies, which acquire potential material from authors represented by agents, select material for publication from the potential material, coordinate the manufacture of books and coordinate the distribution of the books through retail sources.

With the emergence of eReaders such as Amazon.com's™ Kindle™ and well received tablet computers such as Apple's™ iPad™, digital publishing has emerged as a credible alternative to the traditional publishing structure. Digital publishing bypasses the step of manufacturing books, but digital publishing still requires the selection of material by publishing companies.

The selection of material by publishing companies is a significant cost that limits the profits authors receive from the sale of their material and limits the number and type of material that is published. Publishing companies employ people who require salaries, and publishing companies make profits, both of which detract from the profits available to authors. These costs also limit the number of books being published. Further, publishers may have rigid views of what content should be published, and they tend to decline non-traditional content which would otherwise appeal to the public.

One innovation which has attempted to solve this limitation in the traditional publishing model is digital self publishing. Digital self publishing allows an author to convert raw content into a marketable eBook, which can be purchased by a consumer and read on an eReader. Yet, digital self publishing is limited because the self published eBooks lack the credibility and marketing to compete with traditionally published books and eBooks.

Additionally, the twenty-first century has seen the emergence of social media, crowdsourcing and crowdfunding. Crowdsourcing is the concept of performing functions or tasks by an undefined group or community through an open call for assistance. Crowdsourcing takes advantage of the collective sorting efforts of the group to select the best solution to the problem. In the most common example, first the crowd submits solutions to a proposed problem and second, the crowd sorts through the submitted solutions to find the best solution. Crowdfunding is a similar concept based around a group of individuals pooling their money and other resources together to support efforts of other people or organizations. It some instances crowdfunding involves an exchange of money for an ownership interest in the result of the efforts, referred to as crowd investing. In other instances, the consideration to the crowd is that the endeavor comes to fruition and is not lost due to an inability to raise the necessary funding.

### SUMMARY OF THE INVENTION

There is provided a system and method for selecting content for publication. The system takes advantage of the concepts of crowdsourcing and crowdfunding to form a new and improved publishing model. Users submit a summary or excerpt of their content for publication, which is considered by other users. If users desire to read more of the content, they can support the content (which is equivalent to preordering the book) thereby providing funding for the publication of the content. Upon reaching a first threshold level of funding, the submitting user uploads the full content to ensure the content exists in its entirety. Upon reaching a second threshold level of funding, the content is selected for publication.

The system comprises a submission module, a discovery module, a selection module and a store module. Preferably, a profile creation module is also included, though it is not necessary. Each module in the system corresponds to a step in the method.

In the method, preferably, a user first creates a user profile, which will identify the user and allow all content the user submits to be linked to his profile. All new profiles are added to a list of user profiles, which are each linked to profile data. Once the user profile is created, the user is able to submit content via a digital upload. With each new content submission, the user includes content information. The system includes a plurality of content data, all of which are associated with the content. One of the content data includes the number of supporters financially committed to the content—a variable which is preferably used to determine if the book will be selected for publication. Thus, through the discovery process funding is obtained and the level of support is tracked.

As content is submitted to the system, it becomes available for other users to browse and discover. In the discover module, content is displayed to browsing users who may fund specific content that they would like to be published. Users can directly contribute to the content in a variable dollar amount. Users are only charged if the content reaches a threshold of supporters, and all support levels (preferably ranging from $10-$500), guarantee a supporter at minimum, a copy of the published book. Support levels increase with new incentives (i.e., discovery recognition, a copy of the original manuscript, a dedication, etc.) Additionally, browsing users can share the book with other users or indicate approval of the book through a Facebook™ “like” metric and a five star rating system, which are recorded and tracked as content data.

Users will browse through content and identify content that appeals to them and which they want to see published. While the browsing users may not be able to fully fund the publication of a particular content, a browsing user will be able to provide a small amount of funding for a content he wants to see published. The system will track the number of users supporting each content. Additionally, the funds raised will support at least a portion of the initial publication costs.

Content with a threshold number of supporters is selected for publication. The threshold is preferably 2000 and is based on establishing a significant built-in audience for the content prior to its publication to increase commercial success and viability.

Finally, all content which has been selected for publication is then moved from the discover module to the Store module to be displayed for purchasing. A user selects the published content he wishes to purchase and then selects whether he wants the purchase to be in the form of a traditional paper book which will be shipped to him or if the purchase will be in the form of a digital copy, which will be downloaded to be saved on a portable digital device. Published content is also available through other booksellers (digital and physical).

An objective of the present invention is to overcome the limitations of the traditional publishing model. Allowing a large group of users, instead of a limited group of publishing executives, to view content and provide funding to the content will allow more content to be published and at the same time will better identify the content the consuming public is most interested in.

### BRIEF DESCRIPTION OF THE DRAWINGS

The above-described and other advantages and features of the present disclosure will be appreciated and understood by those skilled in the art from the following detailed description and drawings of which,

FIG. 1 shows one embodiment of a flow chart illustrating the cooperating modules of the system and method for selecting content for publication of the present invention;

FIG. 2 shows one embodiment of a flow chart illustrating the architecture of the profile creation module of the system and method for selecting content for publication of the present invention;

FIG. 3 shows one embodiment of a chart illustrating the profile data field of the profile creation module of the system and method for selecting content for publication of the present invention;

FIG. 4 shows one embodiment of a flow chart illustrating the submit module of the system and method for selecting content for publication of the present invention;

FIG. 5 shows one embodiment of a chart illustrating the content information field fo the submit module of the system and method for selecting content for publication of the present invention;

FIG. 6 shows one embodiment of a flow chart illustrating the content data field of the submit module of the system and method for selecting content for publication of the present invention;

FIG. 7 shows one embodiment of a chart illustrating the discover module of the system and method for selecting content for publication of the present invention;

FIG. 8 shows one embodiment of a flow chart illustrating the selection module of the system and method for selecting content for publication of the present invention; and

FIG. 9 shows one embodiment of a flow chart illustrating the store module of the system and method for selecting content for publication of the present invention.

### DETAILED DESCRIPTION OF THE INVENTION

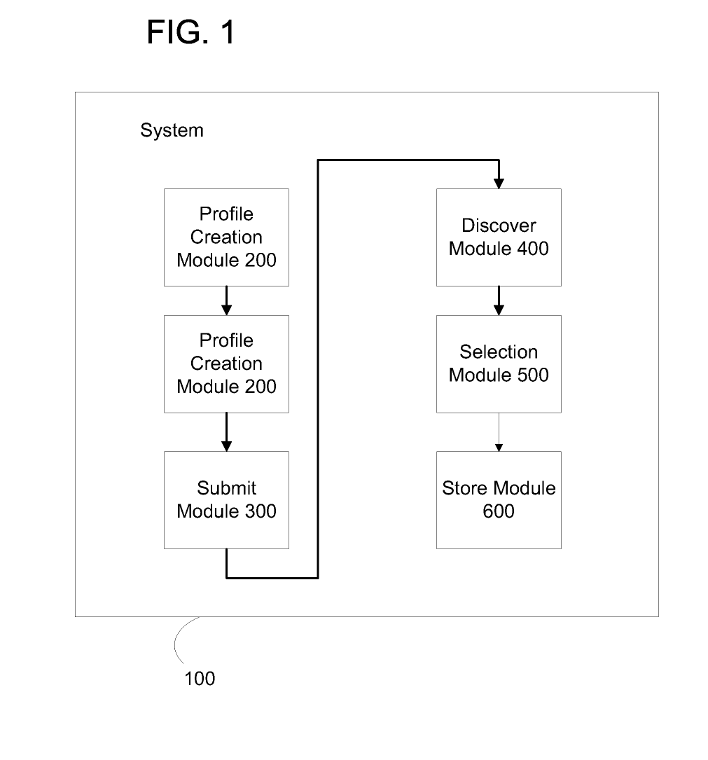

With reference to FIGS. 1 through 8, there is shown a system and method for selecting content 110 for publication. FIG. 1 illustrates the architecture of System 100, which includes a number of modules comprising the overall system. As shown in FIG. 1 and as discussed below, the entire system facilitates the transition from content 110, which has been created by a creative user 120, to a published work 130 which is purchased by a user 140. The overall process preferably includes creating a user profile 150, submitting content 110, discovering and viewing content 110, selecting content 110, publishing selected content 110 as published work 140 and finally selling the published work 130.

The first module is a Profile Creation Module 200; the second module is a Submit Module 300, where a creative user 120 submits content 110 to a server; the third module is a Discover module 400, where user 140 browses already submitted content 110; the fourth module is a Content Selection Module 500, where content 110 is selected for publication; and the fifth module is a Store Module 600, where the published work 130 is sold to a user 140. Each module includes a Graphic User Interface (GUI), which is preferably an internet browser supported by computer code.

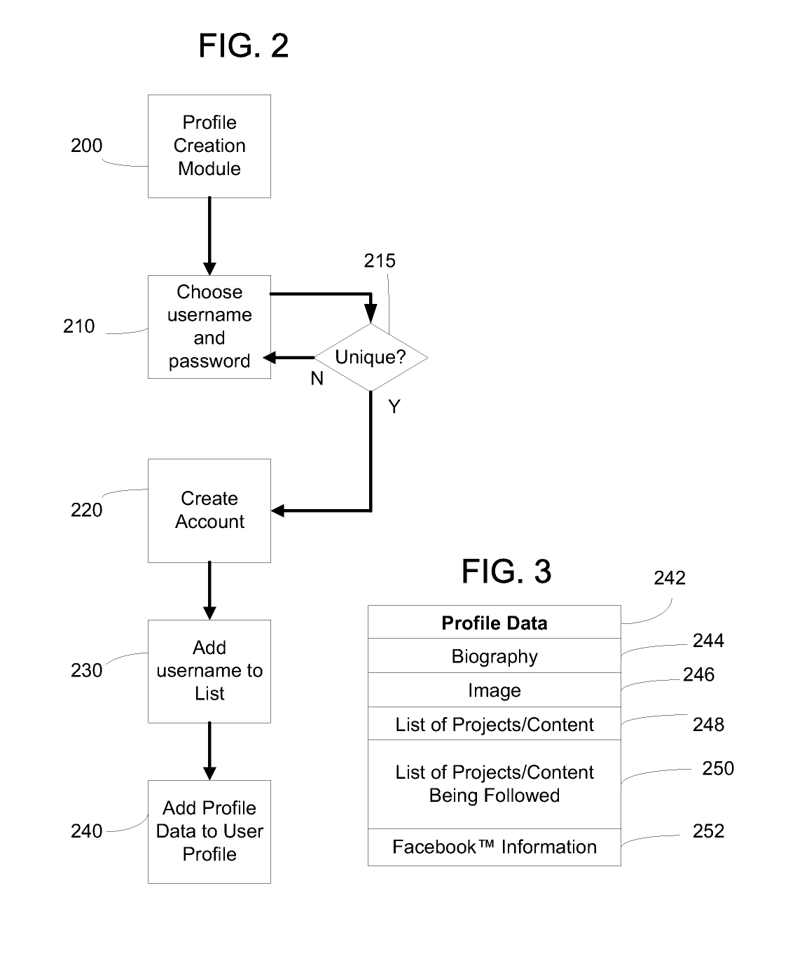

The architecture of the Profile Creation module 200 is illustrated in FIG. 2. The Profile Creation Module 200 facilitates the creation of a user profile 150. It first prompts the creative user 120 (and user 140) to select a unique username 212 and password 214 (step 210). The selected username 212 is compared to a list of all existing usernames 216 (step 215). Each entry in the list of existing usernames 216 corresponds to a user profile 150 having profile data 242. If the selected username 212 is already on the list 216, the selected username 212 is rejected and the creative user 120 is prompted to select a different username. If the selected username 212 is not on the list 216, a new account is created (step 220) and the selected username 212 is added to the list 216.

Once the username 212 is added to the list 216, the creative user 120 is prompted to add profile data 242 (step 240). Profile data 242 preferably includes: a biography 244, the password 214, an image of the author 246, a list of projects/content 248, a list of projects/content the user 140 is following 250 and a link to Facebook™ information 252. Preferably, all of the profile data 242, other than the password 214, is displayed to the user 140 viewing the user profile 150.

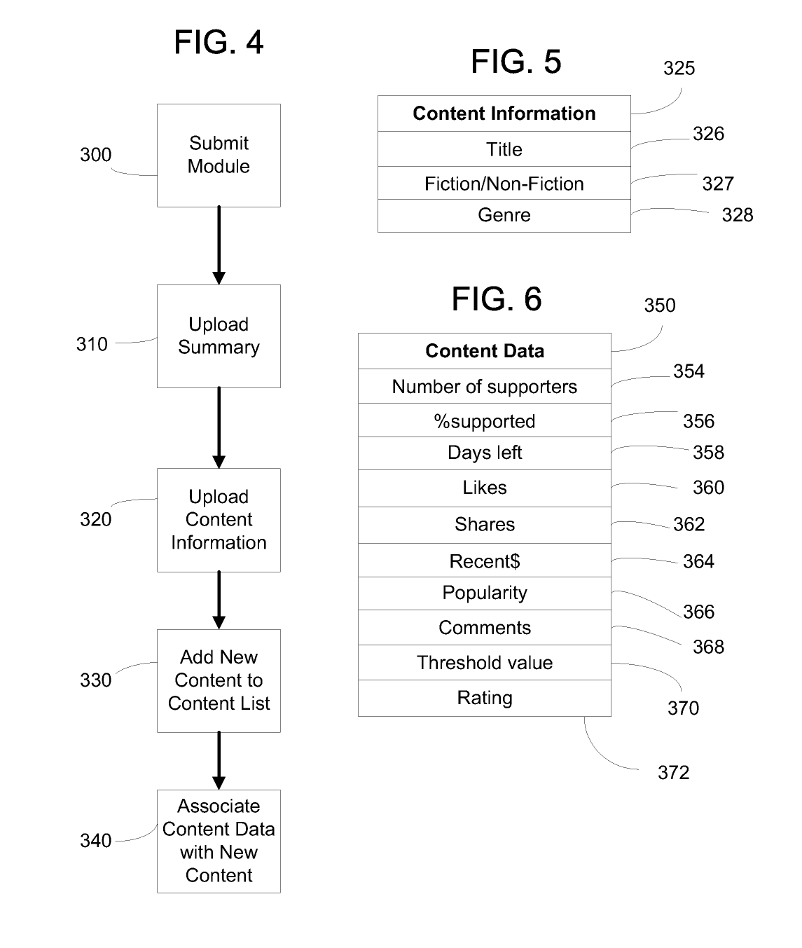

As illustrated in FIG. 4, in the Submit Module 300 the creative user 120 uploads a summary 312 (preferably ten pages) of the content 110 to the server 160 (step 310). In addition to submitting the summary 312 to the server 160, the creative user 120 submits content information 325 which includes a plurality of fields identifying the content 110 (step 320). Content information 325 preferably includes: title 326, fiction/non-fiction 327, and genre 328. The content information 325 may be used as input by the creative user 120 or may be edited by an administrator after being input.

Once submitted, the content 110 is added to a content list 332 (step 330). Content list 332 comprises a complete table of all submitted content 110. Each entry in the content list 332 is associated with a plurality of content data 350 (step 340), preferably including: number of supporters 354, % supported 356, days left 358, likes 360, shares 362, recent$ 364, popularity 366, and comments 368. Title 325 is first input by the creative user 120 and may be altered by an administrator. Number of supporters 354 is a variable value which begins at zero and is increased towards a threshold value 370, which is preferably 2,000, as number of supporters 354 increases. (The receipt of support and the selection of content 110 for publication is described in association with the Discover Module 400.) % supported 356 is a percentage representation of $raised against the threshold value 370. Days left 358 reflects the number of calendar days left for the content 110 to reach 100% of the threshold value 370 of support. Days left 358 preferably begins at 120 and proceeds to zero, at which time the content 110 is removed from the content list 332. Likes 360 is an incremental denominator which begins at zero and is increased by one when a purchasing user identifies that he likes the content 110 in the Discover Module 400. Shares 362 is the number of times a content 110 is shared by different purchasing users 140 as described in reference to the Discover Module 400. Popularity 366 is a ranking of all available content which is preferably calculated based 50% on the number of supporters 354, 20% on a rating 372, 10% on likes 360, 10% on shares 362, and 10% on the number of times the content has been viewed. Comments 368 is a text field associated with each content 110. Threshold value 370 is preferably 2,000 unique supporters. And lastly, rating 372 is based on a one to five star rating scale, and user 140 may rate content 110. The actual value of rating 372 is an average of all rating input.

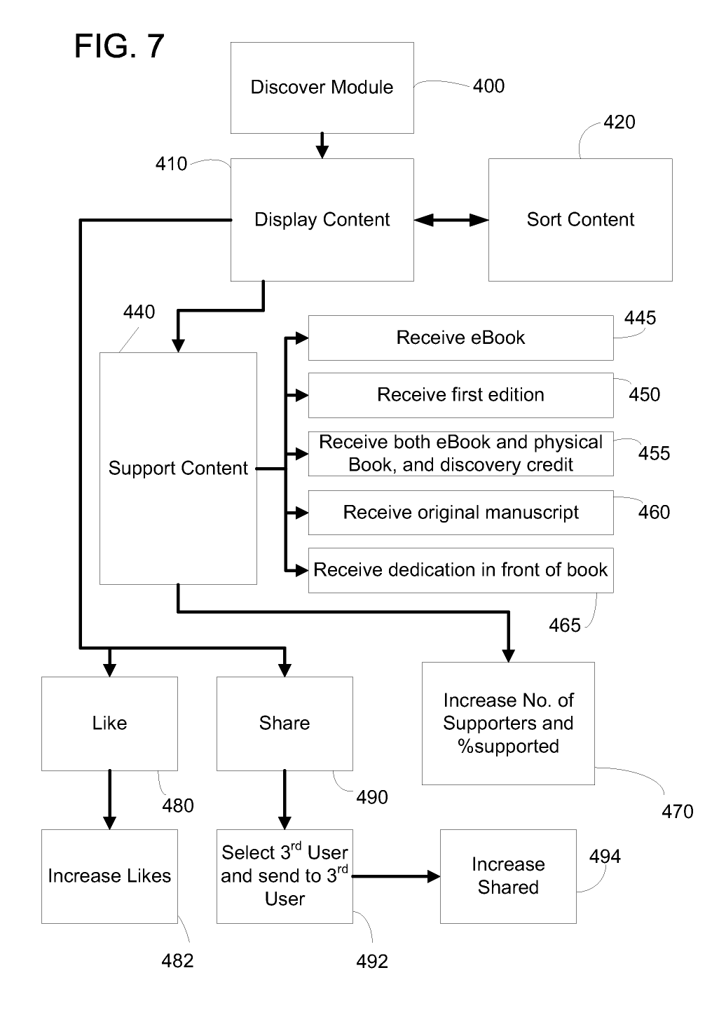

FIG. 7 illustrates the Discover Module 400. The Discover Module 400 allows user 140 to browse the plurality of content 110 and choose to support any of the content 110. The Discover Module 400 displays the content list 332 (step 410) and allows the content list 332 to be sorted (step 420) based on: trending now 422, recommended 424, most popular 426, ending soon 428 or most funded 430.

When a user 140 selects a specific content 110 from the displayed content list 332, the summary 312 is displayed to the user 140 along with an option for inputting to the content's 110 content data 350. FIG. 7 illustrates one example of a system for accepting support for a content 110 (step 440) and providing consideration for the user, if the content 110 is published as a published work 130. In this example, a $10 support will give the user the right to a copy of an eBook (step 445). A $20 support will give the user the right to a first edition (step 450). A $30 support will give the user the right to both an eBook, a first edition and a discovery recognition credit in the appendix of the published work 130 (step 455). A $100 support will give the user the right to receive an original manuscript (step 460). And lastly, a $500 support will give the user the right to receive a dedication in the front of the published work 130 (step 465). Whenever a user 140 supports (step 440) content 110 in any amount, the number of supporters 354 and the % supported 356 are both increased accordingly.

Further, in the Discover Module 400, a user 140 can like a content 110 (step 480) and/or share a content 110 (step 490). To share content 110 (step 492), the list 216 is displayed and the user 140 selects one or more entries from the list 216 (step 492). Once selected, a message is sent to the selected user 140 identifying the content 110 being shared. Any action by the user 140 which changes any of the content data 350 is an input.

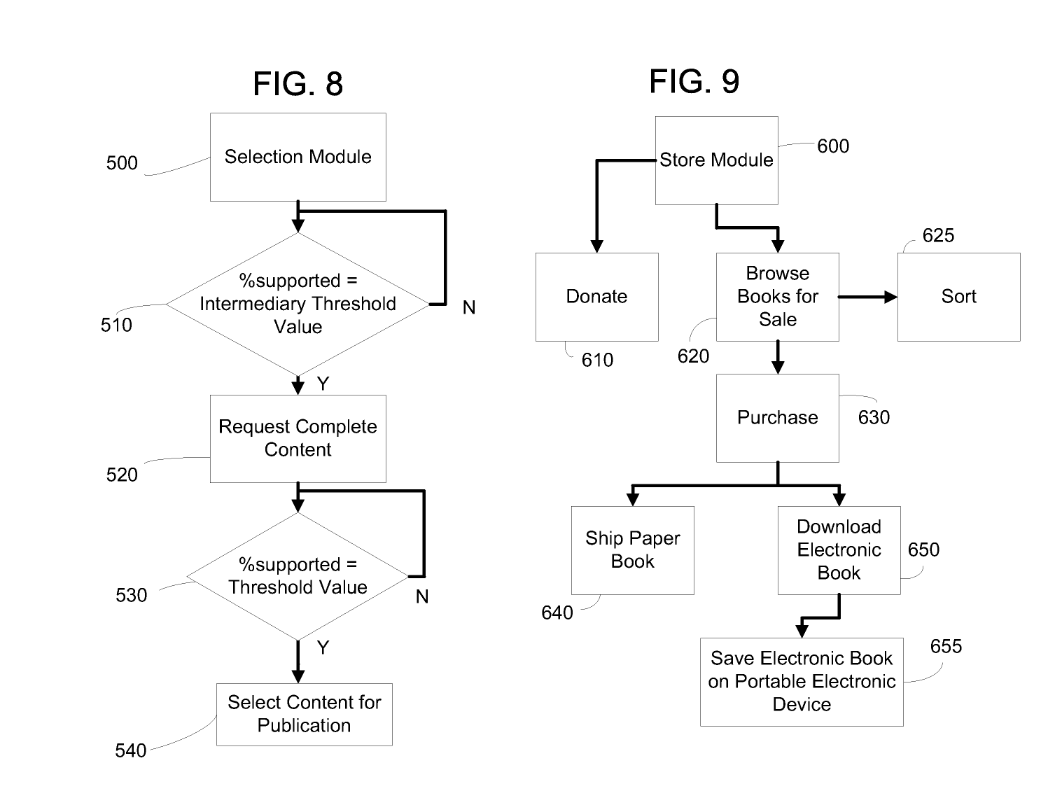

FIG. 8 illustrates the Selection Module 500, where the information obtained in the Discover Module 400 is used to select content 110 for publication. When the content data 350 of % supported 356 reaches an intermediary threshold value 372, preferably 25% (step 510), the system requests the complete content 110 from the creative user 120 (step 520) (initially, only a ten page summary is requested). When the % supported 356 is updated to reach 100% (step 530), the content 110 is selected for publication (step 540). Once selected for publication, the content 110 is converted to a published work 130. The publication process may include proof reading and otherwise revising the content as would be done in traditional publishing. Additionally, the published work 130 may be marketed as it would be by a traditional publishing company.

The Store Module 600 is shown in FIG. 9. The Store Module 600 allows user 140 to purchase published work 130 and other goods or services. User 140 may donate to the system 100 or may browse a listing of books for sale 602 (step 620). The list 602 may be sorted (step 625) based on a number of criteria, including best selling, rating, and alphabetical order. When a published work 130 is purchased (step 630), the purchased work 130 is either shipped in printed form to the user 140 (step 640) or the purchased work is downloaded (step 650) and saved to an electronic memory of the purchasing user's 140 portable electronic device (step 655). Further, published work 130 may be purchased as a pre-order, where the published work 130 has been selected but is not yet available.

The accompanying drawings only illustrate a preferred embodiment of a system and method for selecting content for publication and its constituent steps, however, other types and styles are possible, and the drawings are not intended to be limiting in that regard. Thus, although the description above and accompanying drawings contains much specificity, the details provided should not be construed as limiting the scope of the embodiments but merely as providing illustrations of some of the presently preferred embodiments. The drawings and the description are not to be taken as restrictive on the scope of the embodiments and are understood as broad and general teachings in accordance with the present invention. While the present embodiments of the invention have been described using specific terms, such description is for present illustrative purposes only, and it is to be understood that modifications and variations to such embodiments, including but not limited to the substitutions of equivalent features, materials, or parts, and the reversal of various features thereof, may be practiced by those of ordinary skill in the art without departing from the spirit and scope of the invention.

1. A method for selecting a content from a group of submitted content, and publishing said selected content, the method comprising the steps of:
receiving said content from a creative user and storing said content in computer memory;
displaying said content to a plurality of purchasing users;
receiving and storing an input from one of said plurality of purchasing users;
updating a variable value based on said input, wherein said variable value is a value in a range which increases from an initial value to threshold value;
determining if said variable value has reached said threshold value;
selecting said content for publication, if said variable value has reached said threshold value;
performing a step selected from the group consisting of: printing said selected content on paper, and saving said selected content in an electronic memory of a portable electronic device.

2. The method of claim 1, wherein said variable value is a number of users supporting said content.

3. The method of claim 1, further comprising the step of adapting said selected content to identify a purchaser who provided said input in exchange for recognition credit.

4. The method of claim 1, further comprising the step of receiving a request to share the content from a user.

5. The method of claim 4, further comprising the step of sending the submitted content to a second user.

6. The method of claim 1, wherein the received content is a summary of the received content and a complete received content is requested upon said variable value reaching said threshold value.

7. The method of claim 1, wherein said input is an indication that the user likes the content.

8. The method of claim 1, wherein said displaying is via an internet browser on a computer screen.

9. A system operating on a computer server, said system for selecting content and publishing said content, the system comprising:
a submit module operable to receive said content from a creative user and saving said content in a computer memory of said computer server;
a discovery module operable to display said content to a plurality of purchasing users, to receive input from said plurality of purchasing users and to store the aggregate of said input on said server;
a selection module operable to compare said aggregate to a threshold value and select said content for publishing when said aggregate reaches said threshold value;
a purchase module operable to display said selected content, to receive a purchase order for said selected content and to transfer said selected content to said purchasing user.
